(19) United States
(12) Patent Application Publication
(10) Pub. No.: US 2021/0245811 A1
(43) Pub. Date: Aug. 12, 2021

(54) VEHICLE

(71) Applicant: TOYOTA JIDOSHA KABUSHIKI KAISHA, Toyota-shi (JP)

(72) Inventor: Shigeaki MURATA, Nisshin-shi (JP)

(73) Assignee: TOYOTA JIDOSHA KABUSHIKI KAISHA, Toyota-shi (JP)

(21) Appl. No.: 17/103,529

(22) Filed: Nov. 24, 2020

(30) Foreign Application Priority Data
Feb. 10, 2020 (JP) 2020- 020593

(51) Int. Cl. B62D 21/15; B62D 21/02; B60K 15/067

(52) U.S. Cl. CPC B62D 21/152; B60K 2015/0637; B60K 15/067; B62D 21/02

(57) ABSTRACT

A vehicle includes: a pair of side frames; a mount unit provided between the side frames such that the mount unit is placed at a position overlapping with the side frames when the mount unit is viewed in the vehicle width direction; and a first attachment portion group including a plurality of attachment portions via which a side face of the mount unit is connected to a first side frame. The attachment portions provided in the first attachment portion group include respective elastic portions placed between the first side frame and the mount unit when the respective elastic portions are viewed from above the vehicle. The respective elastic portions included in the attachment portions are placed to overlap each other when the respective elastic portions are viewed in the extending direction of the first side frame.

### CROSS-REFERENCE TO RELATED APPLICATION

This application claims priority to Japanese Patent Application No. 2020-020593 filed on Feb. 10, 2020, incorporated herein by reference in its entirety.

### BACKGROUND

### 1. Technical Field

This disclosure relates to a vehicle.

### 2. Description of Related Art

As a battery unit attachment structure for fixing a battery unit for an electric vehicle to a vehicle body, Japanese Unexamined Patent Application Publication No. 2009-143446 (JP 2009-143446 A) describes a configuration in which the strength of an attachment portion configured to attach a battery unit to a side member of a vehicle is increased by use of a reinforcing member.

### SUMMARY

When a device with a relatively large weight like the above battery unit is attached to a vehicle-body-side member such as a side member with high strength, the rigidity of the member to which the device such as the battery unit is attached increases. At this time, in a case where the side member to which the device is attached is a member serving as a framework of the vehicle, the side member is increased in rigidity, so that deformation such as torsion is restrained. This might decrease steering stability and ride comfort of the vehicle. Further, it is desired that a high-voltage instrument such as a battery to be stored in the battery unit be protected from external force. However, in a case where the device such as the battery unit is attached to a side member with high strength, there is such a possibility that external force to be applied to the vehicle when the vehicle travels is transmitted to the device via the side member, and an undesirably large force is input into the high-voltage instrument via the side member.

This disclosure is achievable in the following aspects.

(1) One aspect of this disclosure provides a vehicle. The vehicle includes a pair of side frames, a mount unit, and a first attachment portion group. The side frames are provided such that the side frames extend in the front-rear direction of the vehicle and are placed to be distanced from each other in the vehicle width direction. The mount unit includes a high-voltage instrument, and the mount unit is provided between the side frames such that the mount unit is placed at a position overlapping with the side frames when the mount unit is viewed in the vehicle width direction of the vehicle. The first attachment portion group includes a plurality of attachment portions via which a side face of the mount unit is connected to a first side frame out of the side frames. The attachment portions provided in the first attachment portion group include respective elastic portions placed between the first side frame and the mount unit when the respective elastic portions are viewed from above the vehicle, and the respective elastic portions are configured to absorb force applied to the attachment portions from the first side frame and the mount unit. The respective elastic portions included in the attachment portions provided in the first attachment portion group are placed to overlap each other when the respective elastic portions are viewed in the extending direction of the first side frame.

In the vehicle of this aspect, the respective elastic portions included in the attachment portions attached to the side frame are placed so as to overlap each other when the respective elastic portions are viewed in the extending direction of the first side frame. This restrains an increase in the rigidity of the side frame, the increase being caused due to attachment of the mount unit to the side frame, and deformation such as torsion easily occurs in the side frame when impact force is input into a vehicle body during traveling of the vehicle. When deformation such as torsion easily occurs and the increase in the rigidity of the side frame is restrained, steering stability and ride comfort of the vehicle can be improved. Further, even in a case where external force to deform the side frame is applied thereto during traveling of the vehicle, the side frame can easily deform to relieve the external force. Hereby, input of the external force into the mount unit can be restrained.

(2) In the vehicle of the above aspect, the vehicle may be a fuel cell vehicle, and the mount unit may include a fuel cell stack as the high-voltage instrument, and a housing in which the fuel cell stack is accommodated. In the vehicle of this aspect, it is possible to restrain an increase in the rigidity of the side frame, the increase being caused due to attachment of the fuel cell unit to the side frame. This can improve the steering stability and ride comfort of the fuel cell vehicle and restrains force to be input into the fuel cell unit.

(3) The vehicle of the above aspect may further include a second attachment portion group including a plurality of attachment portions via which a side face of the mount unit is connected to a second side frame out of the side frames. The attachment portions provided in the second attachment portion group may include respective elastic portions placed between the second side frame and the mount unit when the respective elastic portions are viewed from above the vehicle, and the respective elastic portions are configured to absorb force applied to the attachment portions from the second side frame and the mount unit. The respective elastic portions included in the attachment portions provided in the second attachment portion group may be placed to overlap each other when the respective elastic portions are viewed in the extending direction of the second side frame. In the vehicle of this aspect, both of the side frames can have an effect obtained by the elastic portions absorbing force. This can improve the steering stability and ride comfort of the vehicle by restraining an increase in the rigidity of the side frames and can increase an effect to restrain force to be input into the mount unit.

(4) In the vehicle of the above aspect, an attachment portion placed on the uppermost side among the attachment portions provided in the first attachment portion group and an attachment portion placed on the uppermost side among the attachment portions provided in the second attachment portion group may be placed to overlap each other when the attachment portions are viewed in the vehicle width direction of the vehicle. An attachment portion placed on the lowermost side among the attachment portions provided in the first attachment portion group and an attachment portion placed on the lowermost side among the attachment portions provided in the second attachment portion group may be placed to overlap each other when the attachment portions are viewed in the vehicle width direction. In the vehicle of this aspect, absorption of force by the elastic portions is performed in a good balance between the side frames. This can improve the steering stability and ride comfort of the vehicle by restraining an increase in the rigidity of the side frames and can increase an effect to restrain force to be input into the mount unit.

(5) In the vehicle of the above aspect, the respective elastic portions included in the attachment portions provided in the first attachment portion group may have the same magnitude and may be placed to be aligned along the extending direction of the first side frame. With the vehicle of this aspect, it is possible to improve the steering stability and ride comfort of the vehicle by restraining an increase in the rigidity of the side frames and to further increase an effect to restrain force to be input into the mount unit. This disclosure is achievable in various forms other than a vehicle. For example, the disclosure is achievable in forms of an attachment method of a mount unit, a mount method of a fuel cell unit, and so on.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view illustrating a vehicle;

FIG. 2 is a schematic top view of the vehicle;

FIG. 3 is an explanatory view schematically illustrating a side view of an attachment structure;

FIG. 4 is a sectional view illustrating a state of an attachment portion and a vicinal area around the attachment portion;

FIG. 5 is an explanatory view schematically illustrating a state where the attachment structure is viewed in a Y-direction;

FIG. 6 is an explanatory view schematically illustrating a side view of an attachment structure of a comparative example;

FIG. 7 is an explanatory view schematically illustrating a state where the attachment structure of the comparative example is viewed in the Y-direction;

FIG. 8 is an explanatory view schematically illustrating a side view of an attachment structure; and

FIG. 9 is a sectional view illustrating a state of an attachment portion and a vicinal area around the attachment portion.

### DETAILED DESCRIPTION OF EMBODIMENTS

### A. First Embodiment

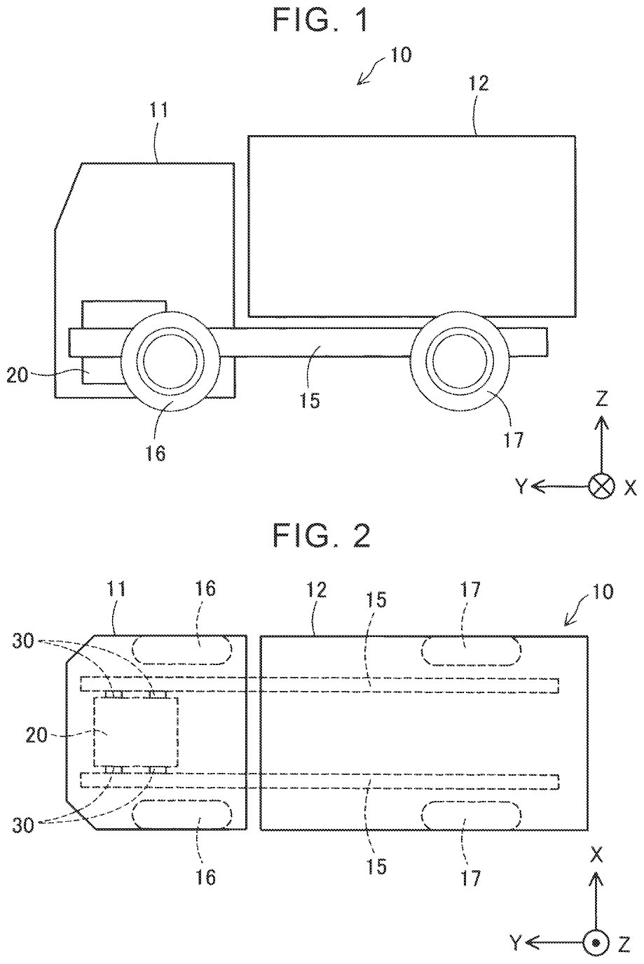

FIG. 1 is a schematic side view illustrating a vehicle 10 as a first embodiment of this disclosure, and FIG. 2 is a schematic top view of the vehicle 10. In FIGS. 1, 2, respective arrows indicating an X-direction, a Y-direction, and a Z-direction perpendicular to each other are illustrated. The X-direction corresponds to the width direction or the right-left direction of the vehicle 10, the Y-direction corresponds to the front-rear direction of the vehicle 10, and the Z-direction corresponds to the height direction of the vehicle 10. The arrows indicating the X-direction, the Y-direction, and the Z-direction are illustrated in other figures (referred to later) so as to correspond to FIG. 1. Note that, in FIG. 2, each portion included in the vehicle 10 is illustrated in a broken line so as to indicate its arrangement place.

In the present embodiment, the vehicle 10 is configured as a commercial vehicle as a freight vehicle. The vehicle 10 includes a cabin 11 where a passenger cabin is formed so that occupants including a driver get thereon, a deck 12 on which a trunk is mounted, and a ladder frame including a pair of side frames 15 and forming a framework of the vehicle 10. The side frames 15 extend in the front-rear direction of the vehicle 10 and are placed to be distanced from each other in the vehicle width direction. That is, the side frames 15 are formed in parallel to each other, and each of the side frames 15 is formed to extend in parallel to the Y-direction. The cabin 11 and the deck 12 are fixed onto the side frames 15. Note that, in FIGS. 1, 2, only the side frames 15 in the ladder frame are illustrated.

In the vehicle 10, a pair of front wheels 16 and a pair of rear wheels 17 are provided such that the front wheels 16 and the rear wheels 17 are attached to respective outer sides of the side frames 15 in the vehicle width direction (the X-direction). The front wheels 16 are driving wheels connected to a driving force source (not shown) and configured to rotate by driving force transmitted from the driving force source. In the present embodiment, the driving force source is constituted by a motor and is driven by output power of a fuel cell unit 20 (described later).

The vehicle 10 is a fuel cell vehicle including a fuel cell as a power source and includes a fuel cell unit 20. The fuel cell unit 20 is configured such that a fuel cell and an instrument integrally attached to a fuel cell body are accommodated in a housing. The “instrument integrally attached to the fuel cell body” includes, for example, sensors, a valve, a pump, a pipe connection member, and so on. The “fuel cell unit” is also referred to as a “mount unit.”

The fuel cell in the present embodiment is a solid polymer fuel cell and is configured as a fuel cell stack in which a plurality of single cells is laminated. Note that the fuel cell included in the fuel cell unit 20 is not limited to the solid polymer fuel cell, and various types of fuel cells such as a solid oxide fuel cell, for example, can be employed.

As illustrated in FIG. 2, the fuel cell unit 20 is placed between the side frames 15 and is fixed to the side frames 15 by an attachment structure including a plurality of attachment portions 30. More specifically, in the present embodiment, a first side face of the fuel cell unit 20 in the right-left direction is connected to a first side frame 15 facing the first side face via two attachment portions 30, and a second side face of the fuel cell unit 20 in the right-left direction is also connected to a second side frame 15 via two attachment portions 30. The two attachment portions 30 via which the first side face of the fuel cell unit 20 in the right-left direction is connected to the first side frame 15 are collectively referred to as a “first attachment portion group.” Further, the two attachment portions 30 via which the second side face of the fuel cell unit 20 in the right-left direction is connected to the second side frame 15 are collectively referred to as a “second attachment portion group.” Further, as illustrated in FIG. 1, the fuel cell unit 20 is provided in a lower part of the cabin 11 such that the fuel cell unit 20 is placed at a position overlapping with the side frames 15 when the fuel cell unit 20 is viewed in the vehicle width direction (the X-direction) of the vehicle 10. The following describes an attachment structure via which the fuel cell unit 20 is attached to the side frames 15.

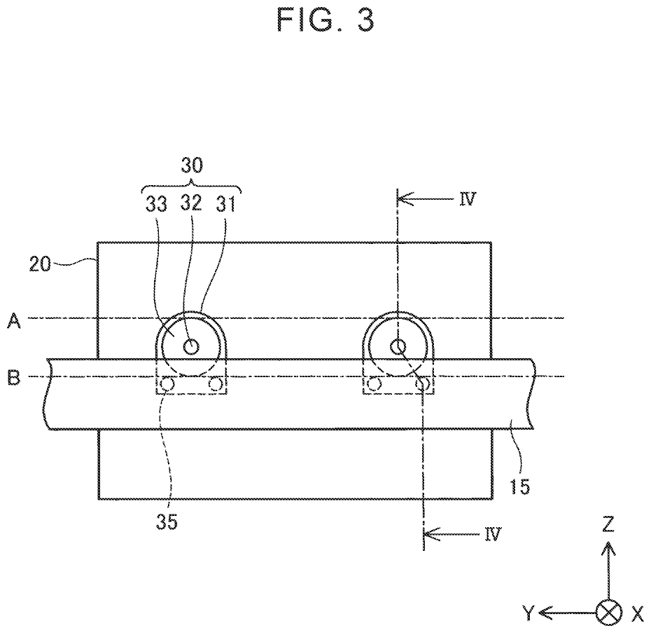

FIG. 3 is an explanatory view schematically illustrating a state where the attachment structure via which the fuel cell unit 20 is attached to the side frame 15 is viewed from the left side of the vehicle 10. As described above, in the present embodiment, two attachment portions 30 (the first attachment portion group) are provided for the first side face of the fuel cell unit 20. In FIG. 3, a range, in the attachment portion 30, that is covered with the side frame 15 is illustrated in a broken line.

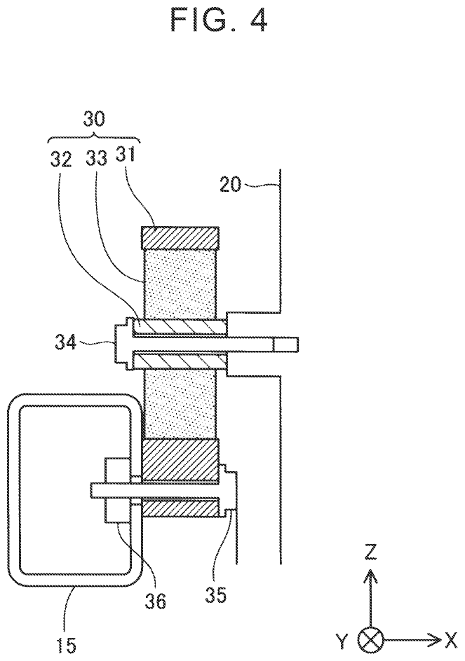

FIG. 4 is a sectional view illustrating a state of the attachment portion 30 provided on the left side of the vehicle 10 and a vicinal area around the attachment portion 30, on a section IV-IV in FIG. 3. As illustrated in FIG. 4, a side face of the housing of the fuel cell unit 20 is fixed to the side frame 15 via the attachment portion 30. In FIG. 4, the side frame 15 is illustrated as a hollow bar-shaped member, but the sectional shape of the side frame 15 may be a different shape.

In the present embodiment, four attachment portions 30 attached to the fuel cell unit 20 (a plurality of attachment portions 30 belonging to the first attachment portion group and a plurality of attachment portions 30 belonging to the second attachment portion group) have the same structure and the same magnitude. Further, in the present embodiment, the attachment portions 30 attached to right and left side faces of the fuel cell unit 20 are placed symmetrically in the right-left direction across the central axis of the vehicle 10 (see FIG. 2). That the attachment portions 30 have the “same magnitude” has a wide concept including a case where the difference in magnitude in the height direction between the attachment portions 30 is 10% or less, for example.

As illustrated in FIGS. 3, 4, the attachment portion 30 includes a mount outer peripheral portion 31, a mount central portion 32, and an elastic portion 33. The mount outer peripheral portion 31 is a frame-shaped member surrounding the mount central portion 32 and the elastic portion 33. The mount outer peripheral portion 31 has a bolt hole into which a bolt 35 is inserted to fasten the attachment portion 30 to the side frame 15 together with a nut 36 (see FIG. 4). In FIG. 3, a state where fastening is performed on two bolt holes by use of respective bolts 35 in the mount outer peripheral portion 31 is illustrated, but the number of bolt holes may be one or may be three or more. The mount outer peripheral portion 31 can be made of a metallic material such as aluminum alloy or iron alloy, or a resin material, for example.

The mount central portion 32 is a member placed in a central part of a frame shape formed by the mount outer peripheral portion 31 so that the mount central portion 32 is distanced from the mount outer peripheral portion 31, and hereby, the mount central portion 32 is surrounded by the frame-shaped mount outer peripheral portion 31. The center of the mount central portion 32 has a threaded hole via which the attachment portion 30 is fastened to the side face of the housing of the fuel cell unit 20 by use of a screw thread 34 (see FIG. 4). The mount central portion 32 can be made of a metallic material such as aluminum alloy or iron alloy, or a resin material, for example.

The elastic portion 33 is a member surrounded by the frame-shaped mount outer peripheral portion 31 and placed to bury the gap between the mount outer peripheral portion 31 and the mount central portion 32. As such, the elastic portion 33 is placed between the mount outer peripheral portion 31 attached to the side frame 15 and the mount central portion 32 attached to the side face of the housing of the fuel cell unit 20, so that the elastic portion 33 constitutes part of a path through which force is transmitted between the side frame 15 and the fuel cell unit 20. The elastic portion 33 can be made of an elastic material such as rubber or thermoplastic elastomer, for example. As the rubber, various types of rubber such as natural rubber (NR), butadiene rubber (BR), styrene butadiene rubber (SBR), and ethylene propylene diene rubber (EPDM) can used. Such an elastic portion 33 absorbs force to be applied to the attachment portion 30 from the side frame 15 and the fuel cell unit 20. As illustrated in FIG. 4, the elastic portion 33 of the present embodiment is placed between the side frame 15 and the fuel cell unit 20 when the elastic portion 33 is viewed from above the vehicle 10.

As described above, two attachment portions 30 are attached to each of the side frames 15, but three or more attachment portions 30 may be provided. When respective elastic portions 33 included in the attachment portions 30 attached to the side frame 15 are viewed in the extending direction of the side frame 15 in a state where the vehicle 10 stops, that is, in a state where no external force is input into the side frame 15, the attachment portions 30, and the fuel cell unit 20, the respective elastic portions 33 are placed in the side frame 15 so as to overlap each other. Particularly, in the present embodiment, the attachment portions 30 have the same structure and the same magnitude, and the attachment portions 30 are placed to be aligned in the extending direction of the first side frame 15. That is, the attachment portions 30 are placed in parallel to the extending direction of the first side frame 15.

On this account, as illustrated in FIG. 3, a straight line A and a straight line B are parallel to the extending direction (the Y-direction) of the side frame 15. The straight line A is a virtual straight line connecting the upper end of the elastic portion 33 of a first attachment portion 30 out of two attachment portions 30 attached to the same side frame 15 to the upper end of the elastic portion 33 of a second attachment portion 30, and the straight line B is a virtual straight line connecting the lower end of the elastic portion 33 of the first attachment portion 30 to the lower end of the elastic portion 33 of the second attachment portion 30. Note that “to be parallel” is not limited to a case where the above straight lines do not intersect with the extending direction (the Y-direction) of the side frame 15 and has a wide concept including a case where the straight lines intersect with the extending direction (the Y-direction) of the side frame 15 at an angle of 10° or less.

In the vehicle 10 of the present embodiment configured as described above, when respective elastic portions 33 included in the attachment portions 30 attached to the side frame 15 are viewed in the extending direction of the side frame 15, the respective elastic portions 33 are placed to overlap each other. On this account, an increase in the rigidity of the side frame 15 due to attachment of a mount unit to the side frame 15 is restrained, and when impact force is input into the vehicle body via the front wheels 16 and the rear wheels 17 during traveling of the vehicle 10, deformation such as torsion can easily occur in the side frame 15. The ladder frame including the side frame 15 is a framework of the vehicle body. Accordingly, when deformation such as torsion easily occurs in the side frame 15 and an increase in the rigidity of the whole ladder frame is restrained, steering stability and ride comfort of the vehicle 10 can be improved. Further, even if external force to deform the side frame 15 is applied thereto during traveling of the vehicle 10, the side frame 15 easily deforms, so that the external force can be relieved. Hereby, input of the external force into the fuel cell unit 20 can be restrained.

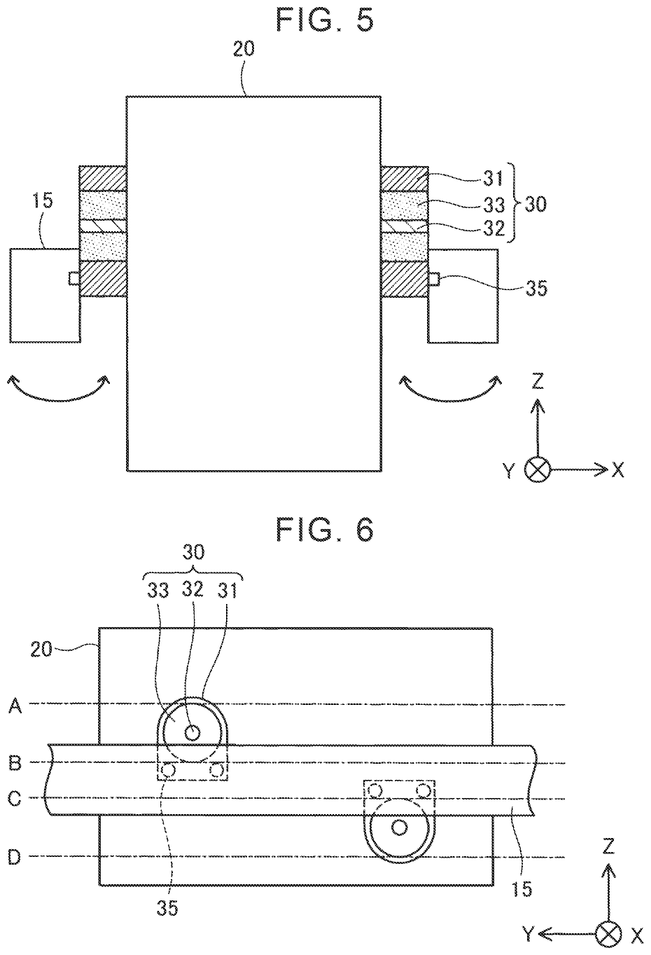

FIG. 5 is an explanatory view schematically illustrating a state where the attachment structure via which the fuel cell unit 20 is attached to the side frames 15 is viewed in the extending direction (the Y-direction) of the side frames 15. In FIG. 5, sections of the attachment portions 30 are illustrated, the sections being parallel to the Z-direction and passing through respective mount central portions 32.

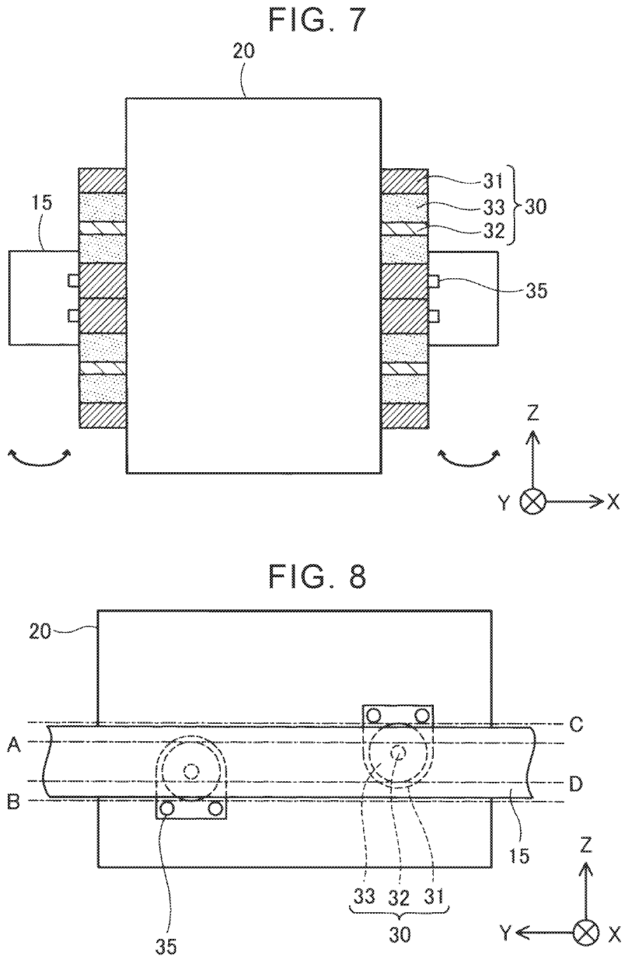

FIG. 6 is an explanatory view schematically illustrating a state where an attachment structure via which the fuel cell unit 20 is attached to the side frame 15 is viewed from the left side of a vehicle of a comparative example, similarly to FIG. 3. Further, FIG. 7 is an explanatory view schematically illustrating a state where the attachment structure via which the fuel cell unit 20 is attached to the side frames 15 is viewed in the extending direction (the Y-direction) of the side frames 15 in the vehicle of the comparative example, similarly to FIG. 5. The vehicle in the comparative example is different from the first embodiment only in the arrangement of the attachment portions 30, and a part common to the first embodiment has the same reference numeral as the first embodiment.

As illustrated in FIGS. 6, 7, in the vehicle of the comparative example, when respective elastic portions 33 included in the attachment portions 30 attached to the side frame 15 are viewed in the extending direction of the side frame 15, the respective elastic portions 33 are placed in the side frame 15 so as not to overlap each other. In FIG. 6, in the elastic portion 33 of a first (front) attachment portion 30 out of the attachment portions 30 attached to the same side frame 15, a virtual straight line parallel to the Y-direction and passing through the upper end of the elastic portion 33 in the Z-direction is illustrated as a straight line A, and a virtual straight line parallel to the Y-direction and passing through the lower end of the elastic portion 33 in the Z-direction is illustrated as a straight line B. Further, in the elastic portion 33 of a second (rear) attachment portion 30 out of the attachment portions 30 attached to the same side frame 15, a virtual straight line parallel to the Y-direction and passing through the upper end of the elastic portion 33 in the Z-direction is illustrated as a straight line C, and a virtual straight line parallel to the Y-direction and passing through the lower end of the elastic portion 33 in the Z-direction is illustrated as a straight line D. As illustrated in FIG. 6, the straight line B passing through the lower end of the elastic portion 33 of the first attachment portion 30 is placed above the straight line C passing through the upper end of the elastic portion 33 of the second attachment portion 30.

Further, in each of the side frames 15 in the vehicle of the comparative example illustrated in FIGS. 6, 7, when the attachment portions 30 are viewed in the extending direction of the side frame 15, a degree to which respective connection parts (respective parts provided in the mount central portions 32) where the attachment portions 30 are connected to the side face of the housing of the fuel cell unit 20 are distanced from each other is larger than that in the vehicle 10 of the embodiment illustrated in FIGS. 3, 5. Also, in each of the side frames 15, when the attachment portions 30 are viewed in the extending direction of the side frame 15, a degree to which respective connection parts (respective parts illustrated as the bolts 35) where the attachment portions 30 are connected to the side frame 15 are distanced from each other is larger than that in the vehicle 10 of the embodiment illustrated in FIG. 5.

As such, in the comparative example in which the fuel cell unit 20 is attached to the side frame 15 by the attachment portions 30 including the elastic portions 33 placed at different positions in the Z-direction, the torsional rigidity of the side frame 15 increases. That is, the side frame 15 is hard to be twisted. On the other hand, in the vehicle 10 of the present embodiment, in each of the side frames 15, the extending direction of a straight line connecting the connection parts (the bolts 35) where the attachment portions 30 provided in the side frame 15 are attached to the side frame 15 is closer to the extending direction of the side frame 15 than that in the comparative example. Further, the extending direction of a straight line connecting the connection parts where the attachment portions 30 provided in the side frame 15 are attached to the fuel cell unit 20 is closer to the extending direction of the side frame 15 than that in the comparative example. As a result, when external force is input, the side frame 15 easily deforms and twists around the central axis extending in the extending direction of the side frame 15. Consequently, steering stability and ride comfort of the vehicle of the comparative example decrease, in comparison with the vehicle 10 of the present embodiment in which torsion of the side frame 15 is allowed more widely. In FIGS. 5, 7, a state where deformation such as torsion occurs in the side frame 15 is indicated by an arrow, and that deformation such as torsion easily occurs in the side frame 15 in the first embodiment as compared with the comparative example is indicated by illustrating the arrow with a large size. Further, in the comparative example, when the rigidity of the side frame 15 is increased as described above, a degree to which the side frame 15 relieves impact force input from outside via wheels is restrained, so that an undesirably large force is easily input into the fuel cell unit 20 via the side frame 15 and the attachment portions 30.

Particularly, like the vehicle 10, in a case where the fuel cell unit 20 is provided between the side frames 15 such that the fuel cell unit 20 is placed at a position overlapping with the side frames 15 when the fuel cell unit 20 is viewed in the vehicle width direction of the vehicle 10, and the side faces of the fuel cell unit 20 are fixed to the side frames 15 via the attachment portions 30, this configuration is advantageous because the configuration can restrain a space that should be secured in the height direction of the vehicle so as to place the fuel cell unit 20. However, in such a configuration, since the side faces of the fuel cell unit 20 are connected to the side frames 15, torsion of the side frames 15 is restricted by the side faces of the fuel cell unit 20. This causes such a problem that the rigidity of the side frame 15 easily increases. Further, in the above configuration, impact force from outside via the wheels is easily input into the side faces of the fuel cell unit 20. Accordingly, in comparison with a case where the fuel cell unit 20 is placed above or below the side frame 15, for example, a problem caused due to transmission of the impact force to the fuel cell unit 20 easily becomes large. With the vehicle 10 of the present embodiment, while the advantageous point in terms of space due to the positional relationship between the fuel cell unit 20 and the side frames 15 is secured, torsion of the side frame 15 can easily occur, thereby making it possible to obtain an effect to improve steering stability and ride comfort and an effect to restrain input of impact force into the fuel cell unit 20.

Further, in the vehicle 10 of the present embodiment, the elastic portion 33 is placed to be sandwiched between the fuel cell unit 20 and the side frame 15 when the elastic portion 33 is viewed from above the vehicle 10 (in a negative Z-direction). On this account, as described above, even when the side frames 15 and the fuel cell unit 20 are placed to overlap each other when they are viewed in the vehicle width direction, and the side faces of the fuel cell unit 20 are connected to the side frames 15, it is possible to restrain the aforementioned inconveniences caused due to such a configuration. That is, since the elastic portion 33 is placed as described above, it is possible to effectively restrain an increase in the rigidity of the side frame 15, the increase being caused when the side faces of the housing of the fuel cell unit 20 are supported by the side frames 15. Further, since the elastic portion 33 is placed as described above, it is possible to restrain input into the side faces of the fuel cell unit 20, the input being caused when the side faces of the housing of the fuel cell unit 20 are supported by the side frames 15.

### B. Second Embodiment

In terms of the vehicle 10 of a second embodiment of this disclosure, FIG. 8 is an explanatory view schematically illustrating a state where an attachment structure via which the fuel cell unit 20 is attached to the side frame 15 is viewed from the left side of the vehicle, similarly to FIG. 3. The vehicle 10 of the second embodiment is different from the vehicle 10 in the first embodiment only in the arrangement of the attachment portion 30, and a part common to the first embodiment has the same reference numeral as the first embodiment. The attachment portion 30 of the second embodiment is configured such that the mount outer peripheral portion 31 is fastened to the side face of the housing of the fuel cell unit 20, and the mount central portion 32 is fastened to the side frame 15.

As illustrated in FIG. 8, in the vehicle 10 of the second embodiment, respective elastic portions 33 included in the attachment portions 30 attached to the side frame 15 are placed in the side frame 15 so as to partially overlap each other when the respective elastic portions 33 are viewed in the extending direction of the side frame 15. In FIG. 8, in the elastic portion 33 of a first (front) attachment portion 30 out of the attachment portions 30 attached to the same side frame 15, a virtual straight line parallel to the Y-direction and passing through the upper end of the elastic portion 33 in the Z-direction is illustrated as a straight line A, and a virtual straight line parallel to the Y-direction and passing through the lower end of the elastic portion 33 in the Z-direction is illustrated as a straight line B. Further, in the elastic portion 33 of a second (rear) attachment portion 30 out of the attachment portions 30 attached to the same side frame 15, a virtual straight line parallel to the Y-direction and passing through the upper end of the elastic portion 33 in the Z-direction is illustrated as a straight line C, and a virtual straight line parallel to the Y-direction and passing through the lower end of the elastic portion 33 in the Z-direction is illustrated as a straight line D. As illustrated in FIG. 8, the straight line A passing through the upper end of the elastic portion 33 of the first attachment portion 30 is placed above the straight line D passing through the lower end of the elastic portion 33 of the second attachment portion 30.

Even with such a configuration, the same effects as those of the first embodiment can be obtained. That is, even in a case where respective elastic portions 33 included in the attachment portions 30 are placed to partially, but not fully, overlap each other when the respective elastic portions 33 are viewed in the extending direction of the side frame 15, it is possible to obtain similar effects to the effect to restrain an increase in the rigidity of the side frame 15 and the effect to restrain input to the side face of the housing of the fuel cell unit 20. Note that, as an overlapping amount between the elastic portions 33 included in the attachment portions 30 when the elastic portions 33 are viewed in the extending direction of the side frame 15 is larger, the above effects can be easily obtained, and this is desirable. Note that, in a case where three or more attachment portions 30 are attached to each of the side frames 15 as the attachment portions 30, respective elastic portions 33 of all the attachment portions 30 attached to the side frame 15 may be placed to partially overlap each other when the respective elastic portions 33 are viewed in the extending direction of the side frame 15.

### C. Third Embodiment

The structure of the attachment portion may be different from those in the first and second embodiments. The following describes a configuration using an attachment portion 130 with a different structure as a third embodiment.

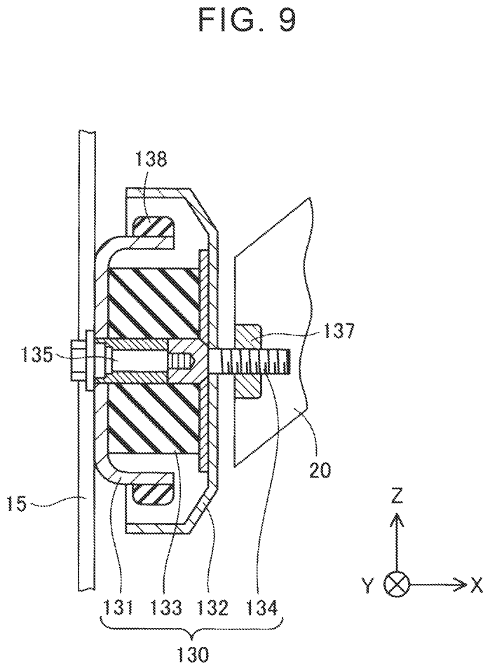

FIG. 9 is a sectional view illustrating a state of the attachment portion 130 used in the vehicle 10 of the third embodiment of this disclosure and a vicinal area around the attachment portion 130, similarly to FIG. 4. The vehicle 10 of the third embodiment has a configuration similar to that in the first embodiment except that the attachment portion 130 is provided instead of the attachment portion 30 of the first embodiment, and a part common to the first embodiment has the same reference numeral as the first embodiment.

The attachment portion 130 of the third embodiment includes a first mount portion 131, a second mount portion 132, an elastic portion 133, and an engageable portion 134. The first mount portion 131 is a plate-shaped member the outer peripheral portion of which is curved in a positive X-direction. A bottom face of the first mount portion 131 on a negative X-direction side makes contact with the side frame 15 and is fastened to the side frame 15 by use of a bolt 135. The second mount portion 132 is a plate-shaped member the outer peripheral portion of which is curved in the negative X-direction. A bottom face of the second mount portion 132 on the positive X-direction side is fastened to the side face of the housing of the fuel cell unit 20 by use of the engageable portion 134. A female screw to which a male screw in a distal end of the bolt 135 is engaged is formed in an end portion of the engageable portion 134 on the negative X-direction side, and a male screw is formed in an end portion of the engageable portion 134 on the positive X-direction side so that the second mount portion is fastened to the side face of the housing of the fuel cell unit 20 together with a nut 137. The elastic portion 133 is provided so as to make contact with respective surfaces of the first mount portion 131 and the second mount portion 132, the surfaces facing each other. In the section illustrated in FIG. 9, the second mount portion 132 is formed to overhang to the outer peripheral side from the first mount portion 131. A rubber stopper 138 is provided on a surface of the curved outer peripheral portion of the first mount portion 131, the surface facing the curved outer peripheral portion of the second mount portion 132. The rubber stopper 138 is configured to restrain the first mount portion 131 from making contact with the second mount portion 132. The first mount portion 131 and the second mount portion 132 can be made of a metallic material such as aluminum alloy or iron alloy, or a resin material, for example. The elastic portion 133 can be made of an elastic material such as rubber or thermoplastic elastomer, for example.

Even with such a configuration, the same effects as those of the first embodiment can be obtained. That is, when respective elastic portions 133 included in the attachment portions 130 are placed to at least partially overlap each other when the elastic portions 133 are viewed in the extending direction of the side frame 15, it is possible to obtain similar effects to the effect to restrain an increase in the rigidity of the side frame 15 and the effect to restrain input to the side face of the housing of the fuel cell unit 20.

### D. Other Embodiments

(D1) In the above embodiments, the fuel cell unit 20 is placed in parallel to the side frames 15. However, the fuel cell unit 20 may be configured differently. For example, for the purpose of improving the water discharge property in the fuel cell, the fuel cell unit 20 may be placed to be inclined from the side frames 15. Even in such a case, by placing respective elastic portions 33 included in the attachment portions 30 so that the respective elastic portions 33 at least partially overlap each other when the elastic portions 33 are viewed in the extending direction of the side frame 15, the same effects as those of the embodiments can be obtained.

(D2) In the above embodiments, the configuration in which respective elastic portions 33 included in the attachment portions 30 attached to the side frame 15 are placed to at least partially overlap each other when the respective elastic portions 33 are viewed in the extending direction of the side frame 15 is applied to both of the side frames 15. However, other configurations may be employed. For example, the second side frame 15 may be provided with a plurality of connecting portions including elastic portions placed so as not to overlap each other when the elastic portions are viewed in the extending direction of the side frame 15. Alternatively, the second side frame 15 may be provided with a single connecting portion as a connecting portion via which the second side frame 15 is connected to the fuel cell unit 20. When at least the first side frame 15 is provided with an attachment structure that establishes the aforementioned positional relationship, the side frame 15 provided with the attachment structure can have similar effects to the effect to restrain an increase in the rigidity of the side frame 15 and the effect to restrain input to the fuel cell unit 20. However, it is desirable to provide the attachment structure that establishes the aforementioned positional relationship for both of the side frames 15, because the above effects are heightened.

(D3) In the above embodiments, the attachment portions 30 attached to the right and left side faces of the fuel cell unit 20 are placed symmetrically in the right-left direction across the center line between the side frames 15 in a top view of the vehicle 10. However, other configurations may be employed. For example, even in a case where the side frames 15 are configured such that respective elastic portions 33 included in the attachment portions 30 are placed to at least partially overlap each other when the respective elastic portions 33 are viewed in the extending direction of the side frames 15, the attachment structures provided in the side frames 15 may be asymmetric. Note that it is desirable that the attachment portion 30 placed on the uppermost side among the attachment portions 30 provided in a first one of the side frames 15 (the attachment portions 30 included in the first attachment portion group) and the attachment portion 30 placed on the uppermost side among the attachment portions 30 provided in a second one of the side frames 15 (the attachment portions 30 included in the second attachment portion group) be placed to overlap each other when they are viewed in the vehicle width direction. Further, it is desirable that the attachment portion 30 placed on the lowermost side among the attachment portions 30 provided in the first attachment portion group and the attachment portion 30 placed on the lowermost side among the attachment portions 30 provided in the second attachment portion group be placed to overlap each other when they are viewed in the vehicle width direction. In such a configuration, absorption of force by the elastic portions 33 is performed in a good balance between the side frames 15, so that the steering stability and ride comfort of the vehicle can be improved by restraining an increase in the rigidity of the side frames 15, and the effect to restrain force to be input into a mount unit can be heightened.

(D4) In the above embodiments, respective elastic portions 33 included in the attachment portions 30 attached to one side frame 15 have the same magnitude and are placed in parallel to each other along the one side frame 15. However, other configurations may be employed. That is, the respective elastic portions 33 included in the attachment portions 30 attached to the one side frame 15 may have different magnitudes. Even in this case, by placing the respective elastic portions 33 included in the attachment portions 30 so that the respective elastic portions 33 at least partially overlap each other when the respective elastic portions 33 are viewed in the extending direction of the side frame 15, the same effects as those of the embodiments can be obtained.

(D5) In the above embodiments, the side frames 15 are formed in parallel to each other, and the side frames 15 are formed to have a given sectional shape and to extend in parallel to the Y-direction. However, other configurations may be employed. For example, the side frames 15 may have a part partially extending in a different direction (inclined at a different angle). The side frames 15 should be formed to extend in a given direction at least at parts where the fuel cell unit 20 is connected to the side frames 15. In the parts where the fuel cell unit 20 is connected, respective elastic portions 33 included in the attachment portions 30 attached to one of the side frames 15 should be placed to at least partially overlap each other when the respective elastic portions 33 are viewed in the given direction where the side frames 15 extend.

(D6) In the above embodiments, the side frames 15 constitute a ladder frame forming the framework of the vehicle body. However, other configurations may be employed. For example, the side frames 15 may be side frames provided in a vehicle having a monocoque structure. Even in a case where the side frames 15 are not constituents of the ladder frame, when the side frames 15 are side frames extending in the front-rear direction of the vehicle and placed to be distanced from each other in the vehicle width direction, similar effects can be provided by applying the technology described in the above embodiments.

(D7) In the above embodiments, the vehicle 10 is a commercial vehicle illustrated in FIG. 1. However, other configurations may be employed. Various types of vehicles such as a freight vehicle having a different configuration from FIG. 1, a bus, and a sport utility vehicle (SUV) can be employed. By applying the technology described in the above embodiments to a vehicle having a pair of side frames, similar effects can be obtained.

(D8) The above embodiments deal with the attachment structure in which the fuel cell unit 20 is attached to the side frames 15. However, the attachment structure may be applied at the time when a mount unit other than the fuel cell unit 20 is attached to the side frame 15. Any mount unit can be employed provided that the mount unit includes a high-voltage instrument, and as the high-voltage instrument, various types of instruments other than the fuel cell stack can be used. The high-voltage instrument can be, for example, an instrument configured such that its operating voltage is a direct current of 60V or more or an alternating current of 30V or more. Further, the operating voltage of the high-voltage instrument can be a direct current of 100V or more. Further, the operating voltage of the high-voltage instrument can be a direct current of 300V or less. Examples of the mount unit include, for example, a battery unit in which a battery as a high-voltage instrument is accommodated, and a power unit in which a high-voltage instrument including at least some of a drive motor, a motor inverter, and a boost converter is accommodated. Further, the mount unit may be a configuration that does not include a housing separated from the high-voltage instrument. The aforementioned attachment structure can be used at the time when such a mount unit is attached to the side frame. This facilitates deformation such as torsion in a side unit and restrains input to the mount unit, so that the same effects as those of the embodiments can be obtained.

The disclosure is not limited to the above embodiments and is achievable in various configurations within a range that does not deviate from the gist of the disclosure. For example, technical features of the embodiments, corresponding to the technical features of the aspects described in SUMMARY, can be replaced or combined appropriately, in order to solve some or all of the problems described above or in order to achieve some or all of the above effects. Further, the technical features can be deleted appropriately if the technical features have not been described as essential in the present specification.

What is claimed is:

1. A vehicle comprising:
a pair of side frames provided such that the side frames extend in a front-rear direction of the vehicle and are placed to be distanced from each other in a vehicle width direction;
a mount unit including a high-voltage instrument, the mount unit being provided between the side frames such that the mount unit is placed at a position overlapping with the side frames when the mount unit is viewed in the vehicle width direction of the vehicle; and
a first attachment portion group including a plurality of attachment portions via which a side face of the mount unit is connected to a first side frame out of the side frames, wherein:
the attachment portions provided in the first attachment portion group include respective elastic portions placed between the first side frame and the mount unit when the respective elastic portions are viewed from above the vehicle, the respective elastic portions being configured to absorb force applied to the attachment portions from the first side frame and the mount unit; and
the respective elastic portions included in the attachment portions provided in the first attachment portion group are placed to overlap each other when the respective elastic portions are viewed in an extending direction of the first side frame.

2. The vehicle according to claim 1, wherein:
the vehicle is a fuel cell vehicle; and
the mount unit includes a fuel cell stack as the high-voltage instrument, and a housing in which the fuel cell stack is accommodated.

3. The vehicle according to claim 1, further comprising a second attachment portion group including a plurality of attachment portions via which a side face of the mount unit is connected to a second side frame out of the side frames, wherein:
the attachment portions provided in the second attachment portion group includes respective elastic portions placed between the second side frame and the mount unit when the respective elastic portions are viewed from above the vehicle, the respective elastic portions being configured to absorb force applied to the attachment portions from the second side frame and the mount unit; and
the respective elastic portions included in the attachment portions provided in the second attachment portion group are placed to overlap each other when the respective elastic portions are viewed in an extending direction of the second side frame.

4. The vehicle according to claim 3, wherein:
an attachment portion placed on an uppermost side among the attachment portions provided in the first attachment portion group and an attachment portion placed on an uppermost side among the attachment portions provided in the second attachment portion group are placed to overlap each other when the attachment portions are viewed in the vehicle width direction of the vehicle; and
an attachment portion placed on a lowermost side among the attachment portions provided in the first attachment portion group and an attachment portion placed on a lowermost side among the attachment portions provided in the second attachment portion group are placed to overlap each other when the attachment portions are viewed in the vehicle width direction.

5. The vehicle according to claim 1, wherein the respective elastic portions included in the attachment portions provided in the first attachment portion group have the same magnitude and are placed to be aligned along the extending direction of the first side frame.
